(19) United States
(12) Patent Application Publication
(10) Pub. No.: US 2026/0052457 A1
(43) Pub. Date: Feb. 19, 2026

(54) METHOD FOR SELECTING NETWORK, COMMUNICATION DEVICE, AND STORAGE MEDIUM

(71) Applicant: Beijing Xiaomi Mobile Software Co., Ltd., Beijing (CN)

(72) Inventor: Jinhua WU, Beijing (CN)

(73) Assignee: Beijing Xiaomi Mobile Software Co., Ltd., Beijing (CN)

(21) Appl. No.: 19/103,737

(22) PCT Filed: Aug. 15, 2022
(86) PCT No.: PCT/CN2022/112523

§ 371 Date: Feb. 13, 2025

(51) Int. Cl. H04W 48/18; H04W 84/04

(52) U.S. Cl. CPC H04W 48/18; H04W 84/042

(57) ABSTRACT

A method for selecting network, performed by a first core network device, including: acquiring a network access parameter, and sending the network access parameter to a terminal, wherein the network access parameter comprises a signal threshold corresponding to access technology, and the network access parameter is used for the terminal to select a public land mobile network (PLMN).

### CROSS REFERENCE TO RELATED APPLICATION

The present application is a U.S. National Stage of International Application No. PCT/CN2022/112523, filed on Aug. 15, 2022, the contents of all of which are incorporated herein by reference in their entireties for all purposes.

### BACKGROUND OF THE INVENTION

Internet of things (IoT), namely, “Internet to which everything is connected”, is a network obtained via extension and expansion of the Internet, and is a huge network formed by combining various information sensing devices to the network, to achieve interconnection and intercommunication among people, machines, and things at any time and in any place.

### SUMMARY OF THE INVENTION

The present disclosure relates to, but not limited to, the field of wireless communication technologies. Embodiments of the present disclosure provide a method for selecting network, a communication device, and a storage medium.

According to a first aspect of the embodiments of the present disclosure, a network selection method is provided, performed by a first core network device. The method includes: acquiring a network access parameter; and sending the network access parameter to a terminal, where the network access parameter includes: a signal threshold corresponding to an access technology; and the network access parameter is used by the terminal for selecting a PLMN.

According to a second aspect of the embodiments of the present disclosure, a network selection method is provided, performed by a second core network device. The method includes: sending a network access parameter to a first core network device, where the network access parameter includes: a signal threshold corresponding to an access technology; and the network access parameter is used by a terminal for selecting a PLMN.

According to a third aspect of the embodiments of the present disclosure, a network selection method is provided, performed by a terminal. The method includes: acquiring a network access parameter from a first core network device, where the network access parameter includes: a signal threshold corresponding to an access technology; and the network access parameter is used by the terminal for selecting a PLMN.

According to a fourth aspect of the embodiments of the present disclosure, a communication device is provided. The communication device includes: one or more processors; and a memory, configured to store an instruction executable by the one or more processors, where the one or more processors are configured to: perform the network selection method according to the first aspect, when running the executable instruction.

According to a fifth aspect of the embodiments of the present disclosure, a non-transitory computer storage medium is provided. The computer storage medium stores a computer-executable program; and the executable program implements the network selection method according to the first aspect, when being executed by a processor.

According to a sixth aspect of the embodiments of the present disclosure, a communication device is provided. The communication device includes: one or more processors; and a memory, configured to store an instruction executable by the one or more processors, where the one or more processors are configured to: perform the network selection method according to the second aspect, when running the executable instruction.

According to a seventh aspect of the embodiments of the present disclosure, a communication device is provided. The communication device includes: one or more processors; and a memory, configured to store an instruction executable by the one or more processors, where the one or more processors are configured to: perform the network selection method according to the third aspect, when running the executable instruction.

According to an eighth aspect of the embodiments of the present disclosure, a non-transitory computer storage medium is provided. The computer storage medium stores a computer-executable program; and the executable program implements the network selection method according to the second aspect, when being executed by a processor.

It should be understood that the above general description and the following detailed description are only exemplary and explanatory, and should not be construed as a limitation to the embodiments of the present disclosure.

### BRIEF DESCRIPTION OF DRAWINGS

The accompanying drawings, which are incorporated into and constitute a part of this specification, illustrate embodiments consistent with the present disclosure and are used together with this specification to explain principles of embodiments of the present disclosure.

FIG. 1 is a schematic structural diagram of a wireless communication system according to an example.

FIG. 2 is a schematic flowchart of a network selection method according to an example.

FIG. 3 is a schematic flowchart of a network selection method according to an example.

FIG. 4 is a schematic flowchart of a network selection method according to an example.

FIG. 5 is a schematic diagram of a system architecture used in a network selection method according to an example.

FIG. 6 is a schematic flowchart of a network selection method according to an example.

FIG. 7 is a schematic flowchart of a network selection method according to an example.

FIG. 8 is a schematic structural diagram of a network selection device according to an example.

FIG. 9 is a schematic structural diagram of a network selection device according to an example.

FIG. 10 is a schematic structural diagram of a network selection device according to an example.

FIG. 11 is a block diagram of Use Equipment (UE) according to an example.

FIG. 12 is a schematic structural diagram of a network device according to an example.

### DETAILED DESCRIPTION OF THE INVENTION

Examples are described in detail herein, examples of which are shown in the accompanying drawings. When the following description refers to the accompanying drawings, unless otherwise indicated, a same reference numeral in different drawings indicates a same element or similar elements. Implementations described in the following description of the examples do not represent all implementations consistent with the embodiments of the present disclosure. Instead, they are merely examples of a device and a method in accordance with some aspects of the embodiments of the present disclosure.

The terms used in the embodiments of the present disclosure are only for the purpose of describing specific embodiments, but are not intended to limit the embodiments of the present disclosure. The singular forms “one”, “the”, and “this” used in the present disclosure are also intended to cover plural forms unless the context clearly indicates other meanings. It should also be understood that the term “and/or” used in this specification includes any or all possible combinations of one or more associated listed items.

It should be understood that although the terms first, second, third, and the like may be used in the embodiments of the present disclosure to describe various information, the information should not be limited by these terms. The terms are only used to distinguish between information of the same type. For example, first information may also be referred to as second information, and similarly, second information may also be referred to as first information, without departing from the scope of the embodiments of the present disclosure. Depending on the context, the word “if” as used herein may be interpreted as “when” or “upon” or “in response to determining”.

In the related art, when an IoT device selects a public land mobile network (PLMN), a PLMN with a poor signal may be selected. As a result, service experience of the IoT device becomes poor.

FIG. 1 is a schematic structural diagram of a wireless communication system according to an example. For ease of understanding the embodiments of the present disclosure, a wireless communication system to which an embodiment of the present disclosure is applicable is first described in detail by using the wireless communication system shown in FIG. 1 as an example. It should be noted that a solution in an embodiment of the present disclosure may also be applied to another wireless communication system, and correspondingly, a name may be replaced with a name of a corresponding function in another wireless communication system.

As shown in FIG. 1, the wireless communication system is a communication system based on a cellular mobile communication technology. The wireless communication system may include: several pieces of User Equipment (UE) 11 and several access devices 12.

The UE 11 may be a device providing a user with voice and/or data connectivity. The UE 11 may communicate with one or more core networks through a radio access network (RAN). The UE 11 may be IoT UE, for example, a sensor device, a mobile phone (also referred to as “cellular” phone), and a computer including the IoT UE, for example, may be a fixed, portable, pocket-sized, handheld, computer built-in, or in-vehicle device. For example, the UE 11 is a station (STA), a subscriber unit, a subscriber station, a mobile station, a mobile, a remote station, an access point, a remote Terminal, an access terminal, a user terminal, a user agent, a user device, or user equipment (UE). Alternatively, the UE 11 may be an unmanned aerial vehicle device. Alternatively, the UE 11 may be a vehicle-mounted device, for example, may be an on-board computer having a wireless communication function, or a wireless communication device externally connected to an on-board computer. Alternatively, the UE 11 may be a roadside device, for example, may be a street lamp, a signal light, or another roadside device having the wireless communication function.

The access device 12 may be a network side device in the wireless communication system. The wireless communication system may be a 4th generation mobile communication technology (4G) system, also referred to as a long term evolution (LTE) system. Alternatively, the wireless communication system may be a 5G system, also referred to as a new radio (NR) system or a 5G NR system. Alternatively, the wireless communication system may be a next-generation system of the 5G system, where an access network in the 5G system may be referred to as a new generation-radio access network (NG-RAN), or an MTC system.

The access device 12 may be an evolved access device (eNB) in the 4G system. Alternatively, the access device 12 may be an access device (gNB), using a concentrated and distributed architecture, in the 5G system. When the access device 12 uses the concentrated and distributed architecture, the access device generally includes a central unit (CU) and at least two distributed units (DU). The central unit is provided with protocol stacks of a packet data convergence protocol (PDCP) layer, a radio link control (RLC) protocol layer, and a medium access control (MAC) layer. The distributed unit is provided with a protocol stack of a physical (PHY) layer. A specific implementation of the access device 12 is not limited on embodiments of the present disclosure.

A wireless connection may be established between the access device 12 and the UE 11 through a wireless air interface. In different implementations, the wireless air interface is a wireless air interface based on a 4G standard; or the wireless air interface is a wireless air interface based on a 5G standard, for example, the wireless air interface is a new radio; or the wireless air interface is a wireless air interface based on a next-generation mobile communication network technology standard of 5G.

In an embodiment, an end to end (E2E) connection or a device to device (D2D) connection may also be established between the user devices or UE 11, for example, in scenarios such as vehicle to vehicle (V2V) communication, vehicle to infrastructure (V2I) communication, vehicle to pedestrian (V2P) communication, and the like in vehicle to everything (V2X) communication.

In an embodiment, the access device 12 may be located in a communication system integrated with a satellite communication system, and can provide a connection service for a satellite, so that the satellite may access a core network. For example, the access device 12 may be an access network device with a satellite gateway function in the communication system, such as a gateway device, a ground station device, a non-terrestrial networks gateway (NTN-Gateway)/satellite gateway, or the like.

In an embodiment, the wireless communication system may further include a core network device 13. The several access devices 12 each are connected to the core network device 13.

In an embodiment, the core network device 13 may be a mobility management entity (MME) in an evolved packet core (EPC). Alternatively, the core network device may be a serving gateway (SGW), a public data network gateway (PGW), a policy and charging rules function (PCRF), or a home subscriber server (HSS), or the like. An implementation form of the core network device 13 is not limited on embodiments of the present disclosure.

In an embodiment, the core network device 13 may be an access and mobility management function (AMF), a unified data management (UDM), a unified data repository (UDR), or the like. An implementation form of the core network device 13 is not limited on embodiments of the present disclosure.

The AMF, the UDM, and the like in the embodiments of the present disclosure may each be implemented by one physical device, or may be implemented by a plurality of physical devices jointly. It may be understood that, the AMF, the UDM, and the like in the embodiments of the present disclosure may each be a logical function module in the physical device, or may be a logical function module including a plurality of physical devices. This is not limited on embodiments of the present disclosure.

For ease of understanding by those skilled in the art, a plurality of implementations are enumerated in the embodiments of the present disclosure to describe the technical solutions of the embodiments of the present disclosure clearly. Certainly, those skilled in the art may understand that a plurality of embodiments provided in the embodiments of the present disclosure may be performed individually, or may be performed after being combined with a method in another embodiment in the embodiments of the present disclosure, or may be performed individually or performed after being combined with some methods in another related art. This is not limited on the embodiments of the present disclosure.

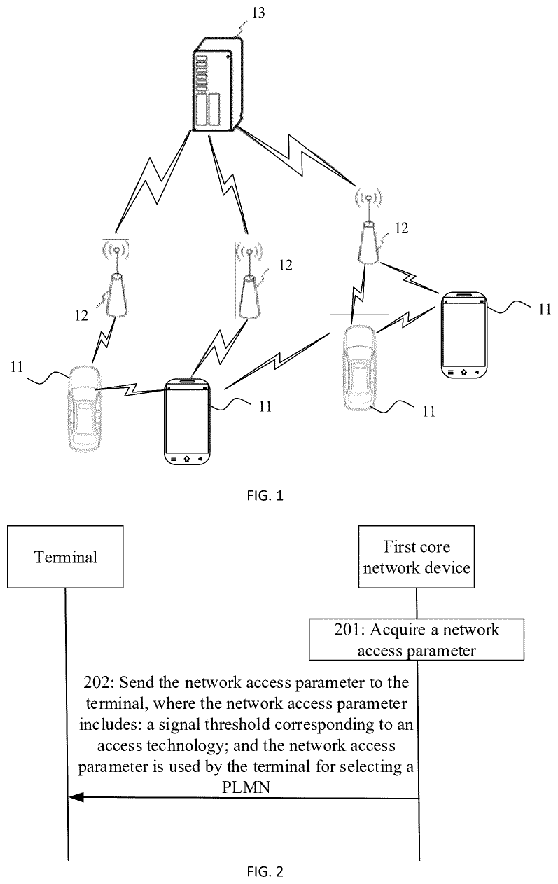

FIG. 2 is a flowchart of a network selection method according to an example. The network select method is performed by a first core network device. As shown in FIG. 2, the method includes steps 201 and 202.

In step 201, a network access parameter is acquired.

In step 202, the network access parameter is sent to a terminal, where the network access parameter includes: a signal threshold corresponding to an access technology; and the network access parameter is used by the terminal for selecting a PLMN.

The first core network device may be an access and mobility management function (AMF). When the terminal is not in a roaming state, the first core network device may be located in a home public land mobile network (HPLMN) of the terminal; or when the terminal is in a roaming state, the first core network device is located in a visited public land mobile network (VPLMN) of the terminal.

The terminal includes, terminal devices that perform communication by using a radio access technology (RAT), terminal devices that perform communication by using the RAT includes, but is not limited to, at least one of: a mobile phone, a tablet computer, a wearable device, an in-vehicle device, or an IoT device.

For example, the terminal is an IoT terminal. The IoT device may include, but not limited to, a sensor, an intelligent instrument, or the like.

The access technology may include, but not limited to, at least one of: narrow band Internet of things (NB-IoT), extended coverage-Global System for Mobile Communications-Internet of things (Extended Coverage-GSM-IoT, EC-GSM-IoT), M1-type evolved UMTS terrestrial radio access (E-UTRA); or M2-type evolved UMTS terrestrial radio access (E-UTRA).

E-UTRA belongs to an air interface of long term evolution (LTE) defined in a 3rd generation partnership project (3GPP) standard protocol.

The signal threshold corresponding to the access technology is used to indicate at least one of a minimum value of a signal strength or a minimum value of a signal quality in a PLMN selected by the terminal for supporting the access technology.

The signal strength may be a reference signal receiving power (RSRP) measurement value. The signal quality may include at least one of: a reference signal receiving quality (RSRQ) or a signal-to-noise and interference ratio (SINR).

The network access parameter includes a signal threshold corresponding to one or more access technologies. A signal threshold corresponding to each access technology may be: an operator controlled signal threshold per access technology.

In some examples, in the above step 201, the acquiring a network access parameter may include: receiving the network access parameter sent by a second core network device.

Herein, the second core network device may be a core network device having at least one of a data management function or a data storage function. For example, the second core network device may be a unified data management (UDM) or a unified data repository (UDR) in an HPLMN of the terminal.

In some examples, the first core network device is an AMF in the HPLMN. The first core network device receives the network access parameter sent by at least one of the UDM or the UDR in the HPLMN.

In some other examples, when the terminal is in the roaming state, the first core network device is an AMF in the VPLMN. The first core network device receives the network access parameter sent by at least one of the UDM or the UDR in the VPLMN.

After the first core network device acquires the network access parameter, the first core network device may directly or indirectly send the network access parameter to the terminal. For example, the first core network device may send the acquired network access parameter to the terminal through a RAN.

An embodiment of the present disclosure provides a network selection method, in which a first core network device sends a network access parameter to a terminal, where the network access parameter includes: a signal threshold corresponding to an access technology; and the network access parameter is used by the terminal for selecting a PLMN. In this way, when the terminal selects the PLMN, a network whose signal is good enough is selected based on the signal threshold corresponding to the access technology, so that the terminal can acquire better service experience.

In an embodiment, the acquiring a network access parameter includes: after a registration request message sent by the terminal is received, acquiring the network access parameter from a second core network device; and the sending the network access parameter to a terminal includes: sending, to the terminal based on the registration request message, a registration accept message carrying the network access parameter.

In some examples, after the registration request message sent by the terminal is received, the first core network device sends a query request to the second core network device, and receives the network access parameter returned by the second core network device based on the query request.

In some examples, the query request carries an identifier of the terminal. The identifier of the terminal may include at least one of: a subscription permanent identifier (SUPI), a subscription concealed identifier (SUCI), a global unique temporary identifier (GUTI), or a permanent equipment identifier (PEI).

In some examples, the first core network device sends, to the second core network device, the query request carrying the identifier of the terminal.

The query request may be a user subscription data acquisition service message, where the user subscription data acquisition service message is a message defined in a standard protocol.

In an example, the second core network device is the UDM; and the first core network device may send the query request to the second core network device through the user subscription data acquisition service message Nudm_SDM_GET (SDM herein is short for Subscriber Data Management), to acquire the network access parameter returned by the second core network device based on the query request.

Herein, Nudm_SDM_GET is a service message defined in a 3GPP standard protocol. The Nudm_SDM_GET service allows a functional entity different from the UDM to request subscription data of a user from the UDM. The UDM provides direct user subscription data acquisition access based on the Nudm_SDM_GET service message.

In some examples, the first core network device performs authentication for the terminal based on the registration request message of the terminal; and sends, to the terminal after authentication and authorization of the terminal, the registration accept message carrying the network access parameter.

In an embodiment, the method further includes: sending an update command to the terminal, where the update command includes an updated network access parameter; or sending a deletion indication for the network access parameter to the terminal, where the deletion indication is used by the terminal for deleting the network access parameter.

When the network access parameter for the terminal is updated, the first core network device sends, to the terminal, the update command including the updated network access parameter; or when the network access parameter for the terminal is deleted, the first core network device sends the deletion indication for the network access parameter to the terminal.

In some examples, the present disclosure includes, but is not limited to, at least one of: the updated network access parameter contains a signal threshold corresponding to a first access technology, and the signal threshold corresponding to the first access technology is not contained in the network access parameter before update; the network access parameter before update contains a signal threshold corresponding to a second access technology, and the signal threshold corresponding to the second access technology is not contained in the updated network access parameter; or a signal threshold corresponding to a third access technology that is contained in the updated network access parameter is different from a signal threshold corresponding to the third access technology that is contained in the network access parameter before update.

In some examples, the deletion indication for the network access parameter may be used to indicate deletion of signal thresholds in the network access parameter that correspond to one or more access technologies.

In an embodiment, the method further includes: sending a first request to the second core network device, where the first request is used to subscribe to the updated network access parameter of the terminal or the deletion indication from the second core network device.

In some examples, the first core network device sends, to the second core network device, the first request carrying the identifier of the terminal.

The first request may be a first request message of a user subscription data change notification, where the first request message of the user subscription data change notification is a message defined in a standard protocol.

In an example, the second core network device is the UDM; and the first core network device may send the first request to the second core network device through a user subscription data subscription service message Nudm_SDM_Subscribe. When user subscription data corresponding to the identifier of the terminal is changed, the second core network device sends, to the first core network device, a user subscription data change notification corresponding to the identifier of the terminal. The user subscription data change notification includes the update command or the deletion indication for the network access parameter.

In an embodiment, the terminal is an IoT device; and the access technology includes at least one of: a narrow band Internet of things (NB-IoT); an extended coverage-Global System for Mobile Communications-Internet of things (EC-GSM-IoT); M1-type evolved UMTS terrestrial radio access (E-UTRA); or M2-type evolved UMTS terrestrial radio access (E-UTRA).

An access technology supported by the IoT device may include an NB-IoT technology provided based on a low-power wide-area (LPWA) IoT application, and may be implemented, for example, based on at least one of an LTE Cat NB1 or LTE Cat NB2 standard.

The EC-GSM-IoT supported by the IoT device may include: GSM EDGE radio access network (GERAN)-EC-GSM-IoT, where GSM is short for the global system for mobile communications; and EDGE is short for an enhanced data rate for GSM evolution.

The access technology supported by the IoT device may include M1-type E-UTRA (Cat-M1), and may also include M2-type E-UTRA (Cat-M2). Both CAT-M1 and CAT-M2 are communication standards of an IoT application using a cellular network.

It is specified in the 3GPP protocol that an LTE cell supporting CAT-M1 or CAT-M2 may configure one of the following system bandwidths: 1.4 MHz, 3 MHz, 5 MHz, 10 MHz, 15 MHz, and 20 MHz.

It may be understood that the IoT device may further support another access technology, including any one of various RATs that have been developed and various RATs that are being developed currently.

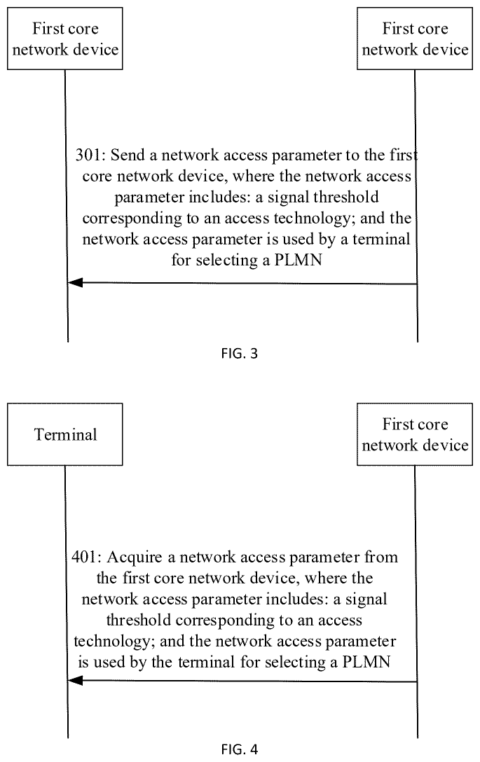

FIG. 3 is a flowchart of a network selection method according to an example. The network select method is performed by a second core network device. As shown in FIG. 3, the method includes step 301.

In step 301, a network access parameter is sent to a first core network device, where the network access parameter includes: a signal threshold corresponding to an access technology; and the network access parameter is used by a terminal for selecting a PLMN.

The second core network device may be a core network device having at least one of a data management function or a data storage function. For example, the second core network device may be a unified data management (UDM) or a unified data repository (UDR) in an HPLMN of the terminal.

The first core network device may be an AMF. When the terminal is not in a roaming state, the first core network device may be located in an HPLMN of the terminal; or when the terminal is in the roaming state, the first core network device is located in a VPLMN of the terminal.

The terminal includes, terminal devices that perform communication by using a radio access technology (RAT), terminal devices that perform communication by using the RAT includes, but is not limited to, at least one of: a mobile phone, a tablet computer, a wearable device, an in-vehicle device, or an IoT device.

For example, the terminal is an IoT terminal. The IoT device may include, but not limited to, a sensor, an intelligent instrument, or the like.

The access technology includes, but is not limited to, at least one of: NB-IoT, EC-GSM-IoT, M1-type E-UTRA; or M2-type E-UTRA.

The EC-GSM-IoT may be: a GERAN-EC-GSM-IoT.

The signal threshold corresponding to the access technology is used to indicate at least one of a minimum value of a signal strength or a minimum value of a signal quality in the PLMN selected by the terminal for supporting the access technology.

The signal strength may be an RSRP measurement value. The signal quality may include at least one of: an RSRQ; or an SINR.

The network access parameter includes a signal threshold corresponding to one or more access technologies. A signal threshold corresponding to each access technology may be: an operator controlled signal threshold per access technology.

An embodiment of the present disclosure provides a network selection method, in which a second core network device sends a network access parameter to a first core network device, where the network access parameter includes: a signal threshold corresponding to an access technology; and the network access parameter is used by a terminal for selecting a PLMN. In this way, when the terminal selects the PLMN, a network whose signal is good enough is selected based on the signal threshold corresponding to the access technology, so that the terminal can acquire better service experience.

In an embodiment, the method further includes: receiving a query request sent by the first core network device; and the sending a network access parameter to a first core network device includes: sending the network access parameter to the first core network device based on the query request.

In some examples, the query request carries an identifier of the terminal. The identifier of the terminal may include at least one of: a subscription permanent identifier (SUPI), a subscription concealed identifier (SUCI), a global unique temporary identifier (GUTI), and a permanent equipment identifier (PEI).

In some examples, the second core network device receives the query request sent by the first core network device and carrying the identifier of the terminal.

The query request may be a user subscription data acquisition service message, where the user subscription data acquisition service message is a message defined in a standard protocol.

In an example, the second core network device is the UDM; and the second core network device may receive, through the user subscription data acquisition service message Nudm_SDM_GET (SDM herein is short for Subscriber Data Management), the query request sent by the first core network device, and return the network access parameter to the first core network device based on the query request through a Nudm_SDM_Notification message.

Herein, Nudm_SDM_GET is a service message defined in the 3GPP standard protocol. The Nudm_SDM_GET service allows a functional entity different from the UDM to request subscription data of a user from the UDM. The UDM provides direct user subscription data acquisition access based on the Nudm_SDM_GET service message.

In an embodiment, the method further includes: sending an updated network access parameter to the first core network device; or sending a deletion indication for the network access parameter to the first core network device.

When a network access parameter for the terminal is updated, the second core network device send, to the first core network device, the update command including the updated network access parameter; or when a network access parameter for the terminal is deleted, the second core network device sends the deletion indication for the network access parameter to the first core network device.

In some examples, the present disclosure includes, but is not limited to, at least one of: the updated network access parameter contains a signal threshold corresponding to a first access technology, and the signal threshold corresponding to the first access technology is not contained in the network access parameter before update; the network access parameter before update contains a signal threshold corresponding to a second access technology, and the signal threshold corresponding to the second access technology is not contained in the updated network access parameter; or a signal threshold corresponding to a third access technology that is contained in the updated network access parameter is different from a signal threshold corresponding to the third access technology that is contained in the network access parameter before update.

In some examples, the deletion indication for the network access parameter may be used to indicate deletion of signal thresholds in the network access parameter that correspond to one or more access technologies.

In an embodiment, the method further includes: receiving a first request sent by the first core network device; and sending the updated network access parameter of the terminal or the deletion indication to the first core network device based on the first request.

In some examples, the second core network device receives the first request sent by the first core network device and carrying the identifier of the terminal.

The first request may be a first request message of a user subscription data change notification, where the first request message of the user subscription data change notification is a message defined in a standard protocol.

In an example, the second core network device is UDM; and the first core network device may send the first request to the second core network device through a user subscription data subscription service message Nudm_SDM_Subscribe. When user subscription data corresponding to the identifier of the terminal is changed, the second core network device sends, to the first core network device, a user subscription data change notification corresponding to the identifier of the terminal. The user subscription data change notification includes the update command or the deletion indication for the network access parameter.

In an embodiment, the terminal is an IoT device; and the access technology includes at least one of: an NB-IoT; an EC-GSM-IoT; M1-type E-UTRA; or M2-type E-UTRA.

An access technology supported by the IoT device may include an NB-IoT technology provided based on an LPWA IoT application, and may be implemented, for example, based on at least one of an LTE Cat NB1 or LTE Cat NB2 standard.

The EC-GSM-IoT supported by the IoT device may include: a GERAN-EC-GSM-IoT.

The access technology supported by the IoT device may include M1-type E-UTRA (Cat-M1), and may also include M2-type E-UTRA (Cat-M2). Both CAT-M1 and CAT-M2 are communication standards of an IoT application using a cellular network.

It is specified in the 3GPP protocol that an LTE cell supporting CAT-M1 or CAT-M2 may configure one of the following system bandwidths: 1.4 MHz, 3 MHz, 5 MHz, 10 MHz, 15 MHz, and 20 MHz.

It may be understood that, the IoT device may further support another access technology, including any one of various RATs that have been developed and various RATs that are being developed currently.

In an embodiment, the first core network device is an access and mobility management function (AMF); and the second core network device is a unified data management (UDM) or a unified data repository (UDR).

In some examples, when the terminal is not in a roaming state, the first core network device is an AMF in an HPLMN of the terminal; or when the terminal is in the roaming state, the first core network device is an AMF in a VPLMN of the terminal.

In some examples, the second core network device is at least one of the UDM or the UDR in the HPLMN.

FIG. 4 is a flowchart of a network selection method according to an example. The network select method is performed by a terminal. As shown in FIG. 4, the method includes step 401.

In step 401, a network access parameter is acquired from a first core network device, where the network access parameter includes: a signal threshold corresponding to an access technology; and the network access parameter is used by the terminal for selecting a PLMN.

The terminal includes, terminal devices that perform communication by using a radio access technology (RAT), terminal devices that perform communication by using the RAT includes, but is not limited to, at least one of: a mobile phone, a tablet computer, a wearable device, an in-vehicle device, or an IoT device.

For example, the terminal is an IoT terminal. The IoT device may include, but not limited to, a sensor, an intelligent instrument, or the like.

The access technology includes, but is not limited to at least one of: an NB-IoT, an EC-GSM-IoT, M1-type E-UTRA; or M2-type E-UTRA.

The EC-GSM-IoT may be: a GERAN-EC-GSM-IoT.

The signal threshold corresponding to the access technology is used to indicate a minimum value of at least one of a signal strength or a minimum value of a signal quality in the PLMN selected by the terminal for supporting the access technology.

The signal strength may be an RSRP measurement value. The signal quality may include at least one of: an RSRQ; or a SINR.

The network access parameter includes a signal threshold corresponding to one or more access technologies. A signal threshold corresponding to each access technology may be: an operator controlled signal threshold per access technology.

The first core network device may be an AMF. When the terminal is not in a roaming state, the first core network device may be located in the HPLMN of the terminal; or when the terminal is in the roaming state, the first core network device is located in the VPLMN of the terminal.

The network access parameter may be acquired by the first core network device from a second core network device.

Herein, the second core network device may be a core network device having at least one of a data management function or a data storage function. For example, the second core network device may be a unified data management (UDM) or a unified data repository (UDR) in the HPLMN of the terminal.

The terminal may receive the network access parameter sent by the first core network device through a radio access network.

An embodiment of the present disclosure provides a network selection method, in which a terminal acquires a network access parameter from a first core network device, where the network access parameter includes: a signal threshold corresponding to an access technology; and the network access parameter is used by a terminal for selecting a PLMN. In this way, when the terminal selects the PLMN, a network whose signal is good enough is selected based on the signal threshold corresponding to the access technology, so that the terminal can acquire better service experience.

In an embodiment, the method further includes: selecting the PLMN based on the signal threshold corresponding to the access technology.

In an embodiment, the selecting the PLMN based on the signal threshold corresponding to the access technology may include one of: if the signal threshold corresponding to the access technology includes a signal strength threshold, selecting, by the terminal from at least one PLMN corresponding to the access technology, a PLMN whose signal strength is greater than the signal strength threshold; if the signal threshold corresponding to the access technology includes a signal quality threshold, selecting, by the terminal from the at least one PLMN corresponding to the access technology, a PLMN whose signal quality is greater than the signal quality threshold; or if the signal threshold corresponding to the access technology includes the signal strength threshold and the signal quality threshold, selecting, by the terminal from the at least one PLMN corresponding to the access technology, a PLMN whose signal strength is greater than the signal strength threshold and whose signal quality is greater than the signal quality threshold.

In an embodiment, if the terminal supports a plurality of access technologies, the selecting the PLMN based on the signal threshold corresponding to the access technologies may include: selecting a target access technology from the plurality of access technologies supported by the terminal; and selecting a PLMN based on a signal threshold corresponding to the target access technology.

In some examples, the terminal may select, as the target access technology from the plurality of access technologies based on a rank of priorities of the plurality of access technologies, an access technology whose priority is the highest.

In some other examples, the terminal may select, as the target access technology, an access technology preferred by the terminal, where the target access technology may not be the access technology having the highest priority among the plurality of access technologies supported by the terminal.

In an embodiment, the acquiring a network access parameter from a first core network device includes: sending a registration request message to the first core network device; and receiving a registration accept message sent by the first core network device and carrying the network access parameter.

The terminal may directly or indirectly send the registration request message to the first core network device. For example, the terminal may send the registration request message to the first core network device through a RAN/gNB.

The registration request message includes a registration parameter, for example, a registration type, an SUCI or a 5G-GUTI or a PEI, a security parameter, or the like.

The security parameter may be a related parameter used in an authentication process of the terminal and a network side. For example, the security parameter may include an authentication parameter, a key, and the like used in authentication.

The terminal may receive, through the RAN/gNB, the registration accept message sent by the first core network device and carrying the network access parameter. The registration accept message is sent by the first core network device to the terminal after authentication and authorization of the terminal.

In an embodiment, the method further includes: receiving an update command sent by the first core network device, where the update command includes an updated network access parameter; or receiving a deletion indication sent by the first core network device, where the deletion indication is used by the terminal for deleting the network access parameter.

In some examples, the present disclosure includes, but is not limited to, at least one of: the updated network access parameter contains a signal threshold corresponding to a first access technology, and the signal threshold corresponding to the first access technology is not contained in the network access parameter before update; the network access parameter before update contains a signal threshold corresponding to a second access technology, and the signal threshold corresponding to the second access technology is not contained in the updated network access parameter; or a signal threshold corresponding to a third access technology that is contained in the updated network access parameter is different from a signal threshold corresponding to the third access technology that is contained in the network access parameter before update.

In some examples, the deletion indication for the network access parameter may be used to indicate deletion of signal thresholds in the network access parameter that correspond to one or more access technologies.

In an embodiment, the terminal is an IoT device; and the access technology includes at least one of: an NB-IoT; an EC-GSM-IoT; M1-type E-UTRA; or M2-type E-UTRA.

An access technology supported by the IoT device may include an NB-IoT technology provided based on an LPWA IoT application, and may be implemented, for example, based on at least one of an LTE Cat NB1 or LTE Cat NB2 standard.

The EC-GSM-IoT supported by the IoT device may include: a GERAN-EC-GSM-IoT.

The access technology supported by the IoT device may include M1-type E-UTRA (Cat-M1), and may also include M2-type E-UTRA (Cat-M2). Both CAT-M1 and CAT-M2 are communication standards of an IoT application using a cellular network.

It is specified in a 3GPP protocol that an LTE cell supporting CAT-M1 or CAT-M2 may configure one of the following system bandwidths: 1.4 MHz, 3 MHz, 5 MHz, 10 MHz, 15 MHz, and 20 MHz.

It may be understood that, the IoT device may further support another access technology, including any one of various RATs that have been developed and various RATs that are being developed currently.

The following provides several specific embodiments to further explain any embodiment of the present disclosure.

An embodiment of the present disclosure discloses a network selection method, and provides a new parameter “operator controlled signal threshold per access technology” , namely, the network access parameter in each of the foregoing embodiments. The network access parameter is specified by an operator and may be stored in at least one of the UDM or the UDR in a HPLMN of the IoT device.

When selecting a network, the IoT device should take the parameter “operator controlled signal threshold per access technology”into consideration.

The operator specifies the “operator controlled signal threshold per access technology” based on the following information elements (e.g. access technologies and signal thresholds) for the IoT device, and stores the network access parameter: 1. an NB-IoT, and a signal threshold; 2. a GERAN EC-GSM-IoT, and a signal threshold; 3. M1-type E-UTRA, and a signal threshold; 4. M2-type E-UTRA, and a signal threshold; and 5. another access technology obtained via further expansion, and a signal threshold.

The IoT device may support any one or a combination of the foregoing information elements.

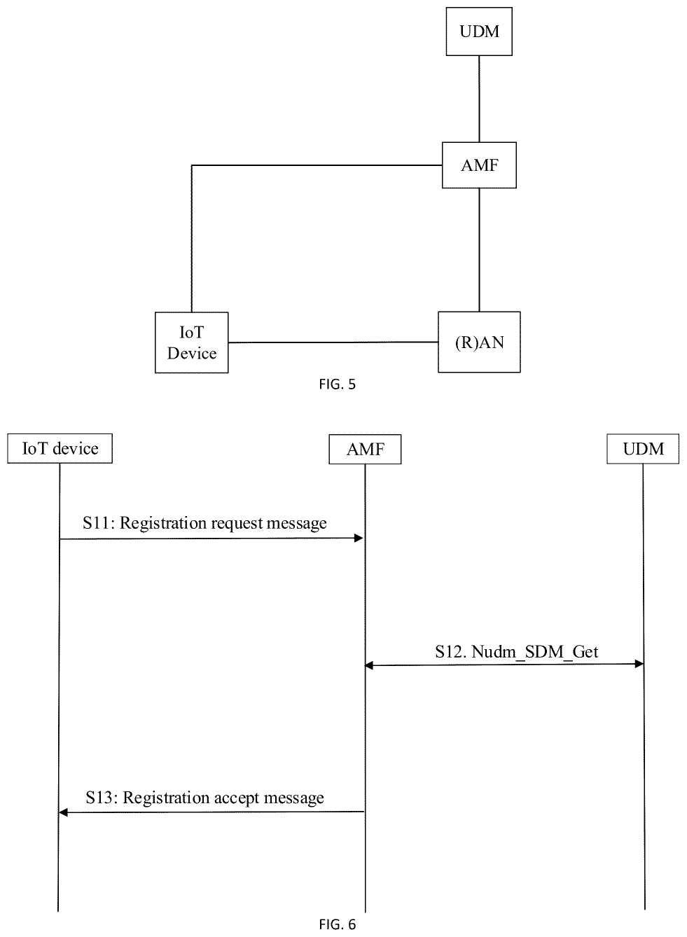

FIG. 5 is a schematic diagram of a system architecture used in a network selection method according to an example. An AMF acquires a network access parameter of an IoT device from UDM, and sends the network access parameter to the IoT device.

In an embodiment, as shown in FIG. 6 that is a flowchart of a network selection method according to an example. The method includes: configuring a network access parameter of an IoT device, and may include steps S11, S12 and S13.

In step S11, a registration request message is sent to an AMF by the IoT through a RAN/gNB, where the registration request message includes a registration parameter, for example, a registration type, an SUCI or a 5G-GUTI or a PEI, a security parameter, or the like.

In step S12, subscription data stored in UDM are retrieved, accessed, and moved by the AMF through Nudm_SDM_Get, and a network access parameter “operator controlled signal threshold per access technology” (e.g. access technology, signal threshold) that is of the IoT device and stored in the UDM, is sent to the AMF by the UDM.

In step S13, after authentication and authorization of UE, registration is completed by AMF by sending a accept message to the UE by the AMF through the RAN/gNB, completing, where the message includes the parameter “operator controlled signal threshold per access technology”(e.g. the access technology, the signal threshold) received from the UDM.

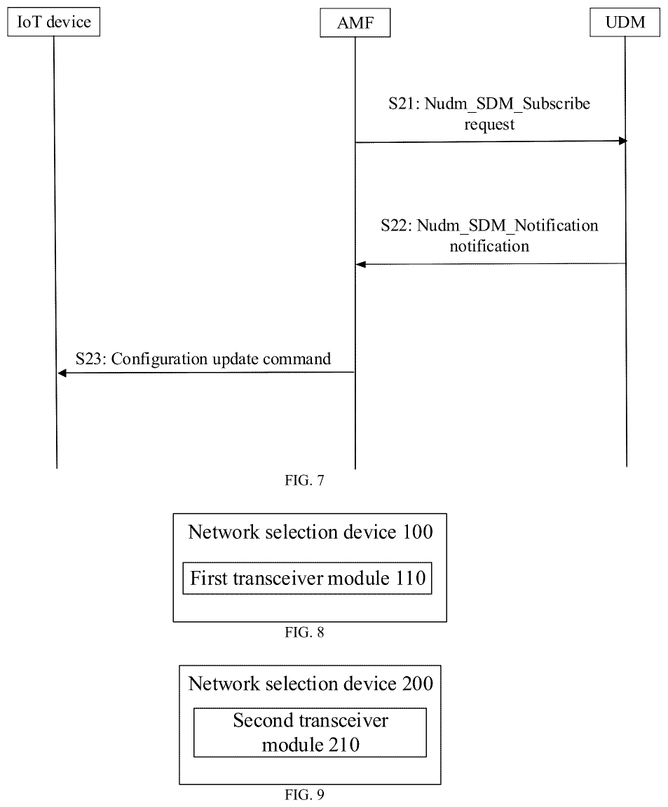

In an embodiment, as shown in FIG. 7 that is a flowchart of a network selection method according to an example. The method includes: updating or deleting a network access parameter of an IoT device, and may include steps S21, S22 and S23.

In step S21, a notification about a UE subscription change is subscribed to by an AMF from UDM by using Nudm_SDM_Subscribe.

In step S22, if a parameter “operator controlled signal threshold per access technology” that is of UE subscription data and stored in the UDM is changed, an updated parameter “operator controlled signal threshold per access technology” is notified to the AMF by the UDM, where the parameter may include a new value, a plurality of values, or a null value, and the null value indicates that the parameter should be deleted; and if the “operator controlled signal threshold per access technology” in the UDM is deleted, allowing the UDM to send a deletion indication to the AMF.

In step S23, a UE configuration update command that contains parameters (e.g. a configuration update indication, the operator controlled signal threshold per access technology) is sent to UE by the AMF; if a deletion indication of the “operator controlled signal threshold per access technology” is received from the UDM, the deletion indication of the “operator controlled signal threshold per access technology” is sent to the UE by the AMF; and UE receives and stores the parameters.

In this way, as the network access parameter is sent to the terminal, the terminal uses the “operator controlled signal threshold per access technology” as a network selection standard in a network selection period, so that a network whose signal strength is good enough can be selected, and the terminal can acquire better service experience.

FIG. 8 is a structural diagram of a network selection device according to an example. The network select device 100 is applied to a first core network device. As shown in FIG. 8, the network selection device 100 includes a first transceiver module 110.

The first transceiver module 110, configured to acquire a network access parameter, and send the network access parameter to a terminal, where the network access parameter includes: a signal threshold corresponding to an access technology; and the network access parameter is used by the terminal for selecting a PLMN.

In an embodiment, the first transceiver module 110 is configured to: after a registration request message sent by the terminal is received, acquire the network access parameter from a second core network device; and the sending the network access parameter to a terminal includes: sending, to the terminal based on the registration request message, a registration accept message carrying the network access parameter.

In an embodiment, the first transceiver module 110 is configured to: send an update command to the terminal, where the update command includes an updated network access parameter; or send a deletion indication for the network access parameter to the terminal, where the deletion indication is used by the terminal for deleting the network access parameter.

In an embodiment, the first transceiver module 110 is configured to: send a first request to the second core network device, where the first request is used to subscribe to the updated network access parameter of the terminal or the deletion indication from the second core network device.

In an embodiment, the terminal is an IoT device; and the access technology includes at least one of: an NB-IoT; an EC-GSM-IoT; M1-type E-UTRA; or M2-type E-UTRA.

FIG. 9 is a structural diagram of a network selection device according to an example. The network select device 200 is applied to a second core network device. As shown in FIG. 9, the network selection device 200 includes a second transceiver module 210.

The second transceiver module 210, configured to send a network access parameter to a first core network device, where the network access parameter includes: a signal threshold corresponding to an access technology; and the network access parameter is used by a terminal for selecting a PLMN.

In an embodiment, the second transceiver module 210 is configured to: receive a query request sent by the first core network device; and send the network access parameter to the first core network device based on the query request.

In an embodiment, the second transceiver module 210 is configured to: send an updated network access parameter to the first core network device; or send a deletion indication for the network access parameter to the first core network device.

In an embodiment, the second transceiver module 210 is configured to: receive a first request sent by the first core network device; and send the updated network access parameter of the terminal or the deletion indication to the first core network device based on the first request.

In an embodiment, the terminal is an IoT device; and the access technology includes at least one of: an NB-IoT; an EC-GSM-IoT; M1-type E-UTRA; or M2-type E-UTRA.

In an embodiment, the first core network device is an AMF; and the second core network device is UDM or UDR.

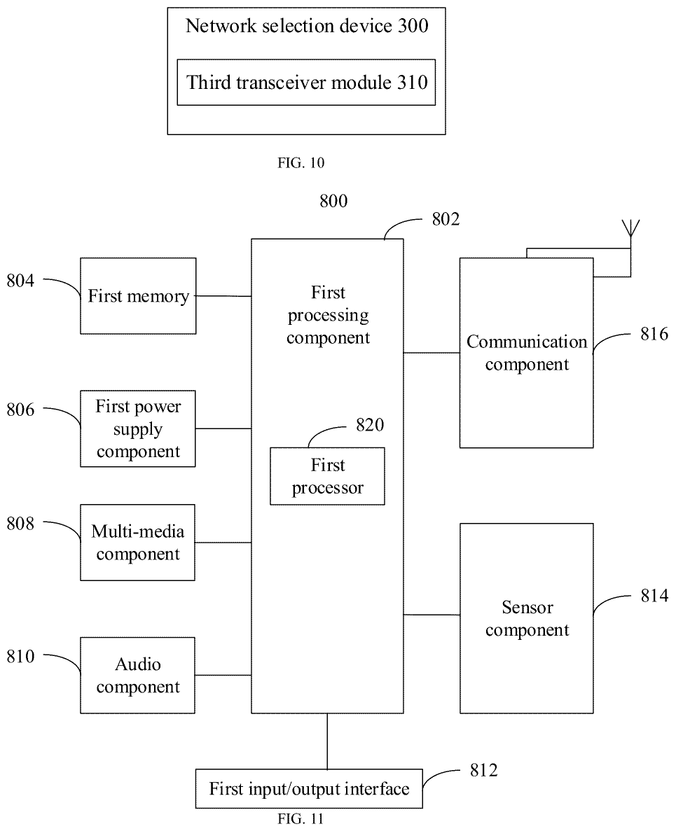

FIG. 10 is a structural diagram of a network selection device according to an example. The network selection device 300 is applied to a terminal. As shown in FIG. 10, the network selection device 300 includes a third transceiver module 310.

The third transceiver module 310, configured to acquire a network access parameter from a first core network device, where the network access parameter includes: a signal threshold corresponding to an access technology; and the network access parameter is used by the terminal for selecting a PLMN.

In an embodiment, the third transceiver module 310 is configured to: send a registration request message to the first core network device; and receive a registration accept message sent by the first core network device and carrying the network access parameter.

In an embodiment, the third transceiver module 310 is configured to: receive an update command sent by the first core network device, where the update command includes an updated network access parameter; or receive a deletion indication sent by the first core network device, where the deletion indication is used by the terminal for deleting the network access parameter.

In an embodiment, the terminal is an IoT device; and the access technology includes at least one of: an NB-IoT; an EC-GSM-IoT; M1-type E-UTRA; or M2-type E-UTRA.

It should be noted that those skilled in the art may understand that the network selection device provided in embodiments of the present disclosure may be executed individually, or may be executed together with some devices in the embodiments of the present disclosure or some devices in the related art.

Regarding the network selection device in the foregoing embodiment, a specific fashion in which each module performs an operation has been described in detail in the embodiments of the method. Details are not described herein.

An embodiment of the present disclosure provides a communication system, including: a first core network device, a second core network device, and a terminal.

The second core network device is configured to send a network access parameter to a first core network device, where the network access parameter includes: a signal threshold corresponding to an access technology; and the network access parameter is used by the terminal for selecting a PLMN.

The first core network device is configured to acquire the network access parameter, and send the network access parameter to the terminal.

The terminal is configured to acquire the network access parameter from the first core network device.

In an embodiment, the terminal is configured to: send a registration request message to the first core network device; and receive a registration accept message sent by the first core network device and carrying the network access parameter.

In an embodiment, the first core network device is configured to: after a registration request message sent by the terminal is received, acquire the network access parameter from the second core network device; and send, to the terminal based on the registration request message, a registration accept message carrying the network access parameter.

In an embodiment, the second core network device is configured to: receive a query request sent by the first core network device; and send the network access parameter to the first core network device based on the query request.

In an embodiment, the first core network device is configured to: send a first request to the second core network device, where the first request is used to subscribe to the updated network access parameter of the terminal or the deletion indication from the second core network device.

In an embodiment, the second core network device is configured to: receive a first request sent by the first core network device; and send the updated network access parameter of the terminal or the deletion indication to the first core network device based on the first request.

In an embodiment, the second core network device is configured to: send the updated network access parameter to the first core network device; or send the deletion indication for the network access parameter to the first core network device.

In an embodiment, the terminal is configured to: receive an update command sent by the first core network device, where the update command includes the updated network access parameter; or receive a deletion indication sent by the first core network device, where the deletion indication is used by the terminal for deleting the network access parameter.

In an embodiment, the first core network device is configured to: send the update command to the terminal, where the update command includes the updated network access parameter; or send the deletion indication for the network access parameter to the terminal, where the deletion indication is used by the terminal for deleting the network access parameter.

In an embodiment, the terminal is an IoT device; and the access technology includes at least one of: a narrow band Internet of things (NB-IoT); an extended coverage-Global System for Mobile Communications-Internet of things (Extended Coverage-GSM-IoT, EC-GSM-IoT); M1-type evolved UMTS terrestrial radio access (E-UTRA); or M2-type evolved UMTS terrestrial radio access (E-UTRA).

In an embodiment, the first core network device is an access and mobility management function (AMF); and the second core network device is a unified data management (UDM) or a unified data repository (UDR).

An embodiment of the present disclosure provides a communication device, including: a memory, configured to store an instruction executable by a processor; and one or more processors, connected to the memory.

The one or more processors are configured to perform the network selection method provided in any one of the foregoing technical solutions.

The one or more processors may include various types of storage media. The storage medium is a non-transitory computer storage medium that can still remember, after the communication device is powered down, information stored in the storage medium.

Herein, the communication device includes: UE or a core network device. The core network device may be at least one of the first core network device or the second core network device described above.

The one or more processors may be connected to the memory through a bus or the like, and is configured to read an executable program stored in the memory, for example, at least one of the network selection methods shown in FIG. 2 to FIG. 4, FIG. 6, and FIG. 7.

FIG. 11 is a block diagram of User Equipment (UE) 800 according to an example. For example, the UE 800 may be a mobile phone, a computer, a digital broadcast user device, a message transceiving device, a game console, a tablet device, a medical device, a fitness device, a personal digital assistant, an IoT device, or the like.

With reference to FIG. 11, the UE 800 may include one or more of the following components: a first processing component 802, a first memory 804, a first power supply component 806, a multimedia component 808, an audio component 810, a first input/output (I/O) interface 812, a sensor component 814, and a communication component 816.

The first processing component 802 typically controls an overall operation of the UE 800, for example, operations associated with display, phone calls, data communications, camera operations, and recording operations. The first processing component 802 may include one or more first processors 820 to execute instructions to generate all or some of the steps of the method described above. In addition, the first processing component 802 may include one or more modules that facilitate interaction between the first processing component 802 and other components. For example, the first processing component 802 may include a multimedia module to facilitate interaction between the multimedia component 808 and the first processing component 802.

The first memory 804 is configured to store various types of data to support the operations on the UE 800. Examples of such data include instructions for any application program or method operating on the UE 800, contact data, phone book data, messages, pictures, videos, and the like. The first memory 804 may be implemented by any type of volatile or non-volatile storage device or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disc.

The first power supply component 806 supplies power to various components of the UE 800. The first power supply component 806 may include a power management system, one or more power supplies, and other components associated with power generation, management, and distribution for the UE 800.

The multimedia component 808 includes a screen providing an output interface between the UE 800 and a user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense boundaries of a touch or swipe action, but also detect a duration and a pressure associated with the touch or swipe action. In some embodiments, the multimedia component 808 includes a front-facing camera and/or a rear-facing camera. The front-facing camera and/or the rear-facing camera may receive external multimedia data when the UE 800 is in an operating mode, such as a shooting mode or a video mode. Each front-facing camera and rear-facing camera may be a fixed optical lens system or have a focal length and an optical zoom capability.

The audio component 810 is configured to output and/or input audio signals. For example, the audio component 810 includes a microphone (MIC). The microphone is configured to receive external audio signals when the UE 800 is in an operating mode, such as a call mode, a recording mode, and a voice recognition mode. The received audio signal may be further stored in the first memory 804 or sent via the communication component 816. In some embodiments, the audio component 810 further includes a speaker for outputting the audio signals.

The first I/O interface 812 provides an interface between the first processing component 802 and a peripheral interface module; and the peripheral interface module may be a keyboard, a click wheel, a button, and the like. These buttons may include, but not limited to: a home button, a volume button, a start button, and a lock button.

The sensor component 814 includes one or more sensors for providing status assessment of various aspects of the UE 800. For example, the sensor component 814 may detect an on/off state of the UE 800 and relative positions of the components, for example, the component is a display and a keypad of the UE 800. The sensor component 814 may further detect a position change of the UE 800 or a component of the UE 800, presence or absence of contact between the user and the UE 800, an azimuth of the UE 800 or acceleration/deceleration of the UE 800, and a temperature change of the UE 800. The sensor component 814 may include a proximity sensor configured to detect the presence of nearby objects without any physical contact. The sensor component 814 may further include an optical sensor, such as a CMOS or CCD image sensor, to be used in imaging applications. In some embodiments, the sensor component 814 may further include an accelerometer sensor, a gyroscope sensor, a magnetic sensor, a pressure sensor, or a temperature sensor.

The communication component 816 is configured to facilitate communication between the UE 800 and other devices by wired or wireless means. The UE 800 can access a wireless network which is based on a communication standard, such as Wi-Fi, 2G, 3G, 4G, 5G, or a combination thereof. In an example, the communication component 816 receives broadcast signals or broadcast-related information from an external broadcast management system via a broadcast channel. In an example, the communication component 816 further includes a near-field communication (NFC) module to facilitate short-range communication. For example, the NFC module may be implemented based on a radio frequency identification (RFID) technology, an infrared data association (IrDA) technology, an ultra-wideband (UWB) technology, a Bluetooth (BT) technology, and other technologies.

In an example, the UE 800 may be implemented by one or more application-specific integrated circuits (ASICs), digital signal processors (DSPs), digital signal processing devices (DSPDs), programmable logic devices (PLDs), field-programmable gate arrays (FPGAs), controllers, microcontrollers, microprocessors, or other electronic components for performing the network selection method described above.

In an example, a non-transitory computer-readable storage medium including an instruction is further provided, for example, the first memory 804 including an instruction. The instruction may be executed by the first processor 820 of the UE 800 to generate the method described above. For example, the non-transitory computer-readable storage medium may be a ROM, a random access memory (RAM), a CD-ROM, a magnetic tape, a floppy disk, an optical data storage device, or the like.

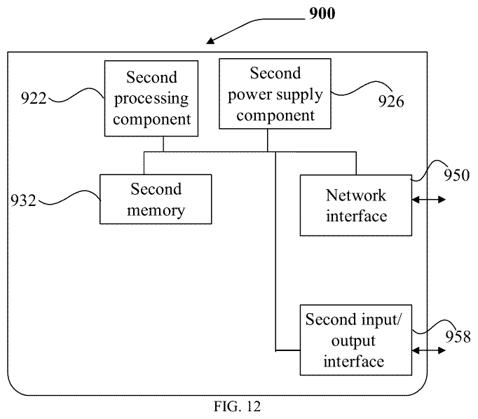

As shown in FIG. 12, an embodiment of the present disclosure shows a structure of a network device. For example, the network device 900 may be provided as a core network device. The communication device may be the first core network device and/or the second core network device described above, or the like.

With reference to FIG. 12, the network device 900 includes a second processing component 922, and further includes one or more second processors, as well as memory resources represented by a second memory 932, which is configured to store an instruction, for example, an application program, executable by the second processing component 922. The application program stored in the second memory 932 may include one or more modules each of which corresponds to a set of instructions. In addition, the second processing component 922 is configured to execute the instructions, to perform the foregoing network selection method applied to the first core network device, or perform the foregoing network selection method applied to the second core network device.

The network device 900 may further include a second power supply component 926 configured to perform power management of the network device 900, a wired or wireless network interface 950 configured to connect the network device 900 to a network, and a second input/output (I/O) interface 958. The network device 900 may operate an operating system stored in the second memory 932, for example, Windows Server™, Mac OS X™, Unix™, Linux™, FreeBSD™, or the like.

Those skilled in the art may readily figure out other implementation solutions of the present disclosure after considering this specification and practicing the invention disclosed herein. The present disclosure is intended to cover any variation, use, or applicable change of the present disclosure. Such variations, uses, or applicable changes follow the general principle of the present disclosure and include common knowledge or conventional technical means in the technical field which is not disclosed in the present disclosure. This specification and the embodiments are merely considered as examples, and the true scope and spirit of the present disclosure are defined by the appended claims.

It should be understood that the present disclosure is not limited to the exact structure that has been described above and shown in the accompanying drawings, and various modifications and changes may be made without departing from the scope of the present disclosure. The scope of the present disclosure is defined by the appended claims.

1. A network selection method, performed by a first core network device, the method comprising:
acquiring a network access parameter; and
sending the network access parameter to a terminal, wherein the network access parameter comprises: a signal threshold corresponding to an access technology; and the network access parameter is used by the terminal for selecting a public land mobile network (PLMN).

2. The method according to claim 1, wherein acquiring the network access parameter comprises:
acquiring the network access parameter from a second core network device after a registration request message sent by the terminal is received; and
sending the network access parameter to the terminal comprises:
sending, to the terminal based on the registration request message, a registration accept message carrying the network access parameter.

3. The method according to claim 1, further comprising:
sending an update command to the terminal, wherein the update command comprises an updated network access parameter; or
sending a deletion indication for the network access parameter to the terminal, wherein the deletion indication is used by the terminal for deleting the network access parameter.

4. The method according to claim 3, further comprising:
sending a first request to the second core network device, wherein the first request is used to request the updated network access parameter of the terminal or the deletion indication from the second core network device.

5. The method according to claim 1, wherein the terminal is an Internet of things (IoT) device; and the access technology comprises at least one of:
a narrow band Internet of things (NB-IoT);
an extended coverage-Global System for Mobile Communications-Internet of things (EC-GSM-IoT);
M1-type evolved UMTS terrestrial radio access (E-UTRA); or
M2-type E-UTRA.

6. A network selection method, performed by a second core network device, the method comprising:
sending a network access parameter to a first core network device, wherein the network access parameter comprises: a signal threshold corresponding to an access technology; and the network access parameter is used by a terminal for selecting a public land mobile network (PLMN).

7. The method according to claim 6, further comprising:
receiving a query request sent by the first core network device; and
sending the network access parameter to the first core network device comprises:
sending the network access parameter to the first core network device based on the query request.

8. The method according to claim 6, further comprising:
sending an updated network access parameter to the first core network device; or
sending a deletion indication for the network access parameter to the first core network device.

9. The method according to claim 8, further comprising:
receiving a first request sent by the first core network device; and
sending the updated network access parameter of the terminal or the deletion indication to the first core network device based on the first request.

10. The method according to claim 6, wherein the terminal is an Internet of things (IoT) device; and the access technology comprises at least one of:
a narrow band Internet of things (NB-IoT);
an extended coverage-Global System for Mobile Communications-Internet of things (EC-GSM-IoT);
M1-type evolved UMTS terrestrial radio access (E-UTRA); or
M2-type evolved UMTS terrestrial radio access (E-UTRA).

11. The method according to claim 6, wherein:
the first core network device is an access and mobility management function (AMF); and the second core network device is a unified data management (UDM) or a unified data repository (UDR).

12. A network selection method, performed by a terminal, the method comprising:
acquiring a network access parameter from a first core network device, wherein the network access parameter comprises: a signal threshold corresponding to an access technology; and the network access parameter is used by the terminal for selecting a public land mobile network (PLMN).

13. The method according to claim 12, wherein acquiring the network access parameter from the first core network device comprises:
sending a registration request message to the first core network device; and
receiving a registration accept message sent by the first core network device and carrying the network access parameter.

14. The method according to claim 12, further comprising:
receiving an update command sent by the first core network device, wherein the update command comprises an updated network access parameter; or
receiving a deletion indication sent by the first core network device, wherein the deletion indication is used by the terminal for deleting the network access parameter.

15. The method according to claim 12, wherein the terminal is an Internet of things (IoT) device; and the access technology comprises at least one of:
a narrow band Internet of things (NB-IoT);
an extended coverage-Global System for Mobile Communications-Internet of things (EC-GSM-IoT);
M1-type evolved UMTS terrestrial radio access (E-UTRA); or
M2-type evolved UMTS terrestrial radio access (E-UTRA).

16.-18. (canceled)

19. A communication device, wherein the communication device comprises:
one or more processors; and
a memory, configured to store an instruction executable by the one or more processors,
wherein the one or more processors are configured to: perform the network selection method according to claim 1 when running the executable instruction.

20. (canceled)

21. A non-transitory computer storage medium storing a computer-executable program, wherein the executable program, when executed by a processor, implements the network selection method according to claim 1.

22. A communication device, wherein the communication device comprises:
one or more processors; and
a memory, configured to store an instruction executable by the one or more processors,
wherein the one or more processors are configured to: perform the network selection method according to claim 6 when running the executable instruction.

23. A communication device, wherein the communication device comprises:
one or more processors; and
a memory, configured to store an instruction executable by the one or more processors,
wherein the one or more processors are configured to: perform the network selection method according to claim 12 when running the executable instruction.

24. A non-transitory computer storage medium storing a computer-executable program, wherein the executable program, when executed by a processor, implements the network selection method according to claim 6.
